(19) United States
(12) Patent Application Publication
(10) Pub. No.: US 2023/0408274 A1
(43) Pub. Date: Dec. 21, 2023

(54) ROUTE RECOMMENDATION SYSTEM, APPARATUS THEREOF, AND METHOD THEREOF

(71) Applicants: Hyundai Motor Company, Seoul (KR); Kia Corporation, Seoul (KR)

(72) Inventor: Pil Sung Kim, Yongin (KR)

(21) Appl. No.: 17/979,652

(22) Filed: Nov. 2, 2022

(30) Foreign Application Priority Data
Jun. 15, 2022 (KR) 10-2022-0073079

(51) Int. Cl. G01C 21/34; G01C 21/36

(52) U.S. Cl. CPC G01C 21/3484; G01C 21/3664

(57) ABSTRACT

A route recommendation system, an apparatus thereof, and a method thereof are provided. The route recommendation system includes a mobile device that obtains first information associated with a passenger initially once, generates fortune information based on the first information by means of an application, determines at least one of a recommended destination, a recommended waypoint, or a combination thereof based on the fortune information, and transmits at least one of information about the recommended destination, information about the recommended waypoint, or a combination thereof and a vehicle that performs route guidance based on the at least one of the information about the recommended destination, the information about the recommended waypoint, or the combination thereof, the at least one being received from the mobile device. In addition, various embodiments recognized through the specification are possible.

### CROSS-REFERENCE TO RELATED APPLICATION

This application claims under 35 U.S.C. § 119(a) the benefit of and priority to Korean Patent Application No. 10-2022-0073079, filed in the Korean Intellectual Property Office on Jun. 15, 2022, the entire contents of which are incorporated herein by reference.

### BACKGROUND

### 1. Technical Field

The present disclosure relates to a route recommendation system, an apparatus thereof, and a method thereof, and more particularly, relates to technologies for recommending a route using fortune information.

### 2. Background

Recently, an infotainment system in a vehicle has been developed in the direction of simply deviating from the level of displaying information and allowing a driver and a passenger to enjoy the time they spend in the vehicle.

However, upon road guidance of original equipment manufacturer (OEM) navigation or a smartphone navigation app, there are no fresh options, such as a minimum time route, a highway priority route, and a free road, which are capable of being selected by the driver regardless of travel time or cost, because there are only dry route guidance options of the same nature.

### SUMMARY

The present disclosure has been made to address the above-mentioned problems occurring in the prior art while advantages achieved by the prior art are maintained intact.

An aspect of the present disclosure provides a route recommendation system for guiding a driver along a recommended route to be lucky by reflecting today's fortune, an apparatus thereof, and a method thereof.

Another aspect of the present disclosure provides a route recommendation system for determining a recommended waypoint or a recommended destination using fortune information, an apparatus thereof, and a method thereof.

Another aspect of the present disclosure provides a route recommendation system for guiding a driver along a route to a recommended waypoint or a recommended destination determined based on fortune information by means of navigation, an apparatus thereof, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a route recommendation system may include a mobile device that obtains first information associated with a passenger, generates fortune information based on the first information by means of an application of the mobile device, determines at least one of: a recommended destination, a recommended waypoint, and/or a combination thereof based on the fortune information, and transmits at least one of: information about the recommended destination, information about the recommended waypoint, and/or a combination thereof and a vehicle that receives the transmit information about the recommended destination, the information about the recommended waypoint, and/or the combination thereof from the mobile device, and perform route guidance based on the information received from the mobile device.

In an embodiment, the mobile device may include a camera. The first information may include at least one type of information input by the passenger and/or acquired by the camera, the information input by the passenger may include at least one of: the passenger's gender, the passenger's year of birth, the passenger's month of birth, the passenger's day of birth, the passenger's time of birth, and/or information about the passenger's blood type, the information acquired by the camera may include information pertaining to the passenger's face, information pertaining to the passenger's palm lines, and/or a combination thereof.

In an embodiment, the vehicle may include a navigation device. The navigation device may display a first user interface (UI) corresponding to a first route option on a display. The application may be automatically run in the mobile device in response to a user input for selecting the first UI.

In an embodiment, the vehicle may include a navigation device. The navigation device may generate a lucky route based on information received from the mobile device, the information received from the mobile device including at least one of: the information about the recommended destination, the information about the recommended waypoint, and/or the combination thereof, display a second UI corresponding to the lucky route on a display, and may perform the route guidance based on the lucky route in response to a user input for selecting the second UI.

In an embodiment, the mobile device may determine the recommended waypoint based on an attention state of the passenger, the fortune information, a current time, a current position of the vehicle, and a set destination. The attention state of the passenger may be determined based on an on state or an off state of a driver attention warning (DAW).

In an embodiment, the mobile device may determine a resting space as the recommended waypoint, if the DAW is in the on state and may determine a restaurant as the recommended waypoint, if the DAW is in the off state and when the current time is a mealtime zone time period.

In an embodiment, the mobile device may determine the recommended destination based on an attention state of the passenger, the fortune information, a current time, and a current position of the vehicle. The attention state of the passenger may be determined based on an on state or an off state of a DAW.

In an embodiment, the mobile device may determine a resting space as the recommended destination, if the DAW is in the on state and may determine a restaurant as the recommended destination, if the DAW is in the off state.

In an embodiment, the fortune information may include information about at least one of a lucky direction, lucky food, a lucky shopping item, a lucky color, a lucky number, and/or a combination thereof.

According to another aspect of the present disclosure, a route recommendation apparatus may include a communication module that communicates with a vehicle and at least one processor that controls the communication module. The at least one processor may obtain first information associated with a passenger, may generate fortune information based on the first information by utilizing an application, may determine at least one of: a recommended destination, a recommended waypoint, and/or a combination thereof based on the fortune information, and may transmit at least one of: information about the recommended destination, information about the recommended waypoint, and/or a combination thereof to the vehicle through the communication module.

In an embodiment, the route recommendation apparatus may further include a camera. The first information may include at least one type of information input by the passenger and/or acquired by the camera, the information input by the passenger may include at least one of: the passenger's gender, the passenger's year of birth, the passenger's month of birth, the passenger's day of birth, the passenger's time of birth, and/or information about a passenger's blood type, the information acquired by the camera may include at least one of: information pertaining to the passenger's face, information pertaining to the passenger's palm lines, and/or a combination thereof.

In an embodiment, the at least one processor may determine the recommended waypoint based on an attention state of the passenger, the fortune information, a current time, a current position of the vehicle, and a set destination. The attention state of the passenger may be determined based on an on state or an off state of a driver attention warning (DAW).

In an embodiment, the at least one processor may determine a resting space as the recommended waypoint, if the DAW is in the on state, and may determine a restaurant as the recommended waypoint, if the DAW is in the off state.

In an embodiment, the at least one processor may determine the recommended destination based on an attention state of the passenger, the fortune information, a current time, and a current position of the vehicle, if a destination is not set. The attention state of the passenger may be determined based on an on state or on an off state of a DAW.

In an embodiment, the at least one processor may determine a resting space as the recommended destination, if the DAW is in the on state, and may determine a restaurant as the recommended destination, if the DAW is in the off state and when the current time is a mealtime zone time period.

In an embodiment, the fortune information may include information about at least one of a lucky direction, lucky food, a lucky shopping item, a lucky color, a lucky number, and/or a combination thereof.

According to another aspect of the present disclosure, a route recommendation method may include obtaining, by a mobile device, first information associated with a passenger, generating, by an application of the mobile device, fortune information based on the first information, determining, by the mobile device, at least one of: a recommended destination, a recommended waypoint, or a combination thereof based on the fortune information, transmitting, by the mobile device, at least one of information about the recommended destination, information about the recommended waypoint, and/or a combination thereof, receiving the information about the recommended destination, the information about the recommended waypoint, and/or the combination thereof, and performing route guidance based on the information received from the mobile device.

In an embodiment, the first information may include at least one type of information input by the passenger and/or acquired by a camera of the mobile device, the information input by the passenger includes at least one of: the passenger's gender, the passenger's year of birth, the passenger's month of birth, the passenger's day of birth, the passenger's time of birth, and/or information about a passenger's blood type, the information acquired by the camera may include at least one of: information pertaining to the passenger's face, information pertaining to the passenger's palm lines, and/or a combination thereof.

In an embodiment, the determining of the at least one of the recommended destination, the recommended waypoint, and/or the combination thereof step may further include determining, by the mobile device, the recommended waypoint based on: an attention state of the passenger, the fortune information, a current time, a current position of a vehicle of the passenger, and a set destination. The attention state of the passenger may be determined based on an on state or on an off state of a driver attention warning (DAW).

In an embodiment, the determining of the at least one of the recommended destination, the recommended waypoint, and/or the combination thereof step may include determining the recommended destination based on an attention state of the passenger, the fortune information, a current time, and a current position of the vehicle. The attention state of the passenger may be determined based on an on state or on an off state of a DAW.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a route recommendation system according to an embodiment of the present disclosure;

FIG. 2 is a block diagram of a route recommendation apparatus according to an embodiment of the present disclosure;

FIG. 3 is a flowchart illustrating a route recommendation method according to an embodiment of the present disclosure;

FIG. 4 illustrates route recommendation in a route recommendation system, an apparatus thereof, and a method thereof according to an embodiment of the present disclosure;

FIG. 5 illustrating an example of determining recommended waypoints based on fortune information in a route recommendation apparatus and a method thereof according to an embodiment of the present disclosure;

FIG. 6 illustrates a flowchart of determining at least one of a recommended destination, a recommended waypoint, or a combination thereof in a route recommendation system and a method thereof according to an embodiment of the present disclosure;

FIG. 7 illustrates recommending a waypoint in a route recommendation system and a method thereof according to an embodiment of the present disclosure;

FIG. 8 illustrates recommending a destination in a route recommendation system and a method thereof according to an embodiment of the present disclosure; and

FIG. 9 illustrates a computing system about a route recommendation system, an apparatus thereof, and a method thereof according to an embodiment of the present disclosure.

### DETAILED DESCRIPTION

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

It is understood that the term “vehicle” or “vehicular” or other similar term as used herein is inclusive of motor vehicles in general such as ground vehicles such as passenger automobiles including sports utility vehicles (SUV), buses, trucks, various commercial vehicles, watercraft including a variety of boats and ships, aircraft (e.g. either or both fixed wing and non-fixed wing), and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

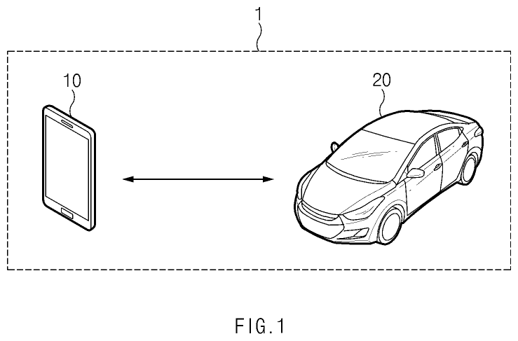

Hereinafter, embodiments of the present disclosure will be described in detail with reference to FIGS. 1 to 9.

FIG. 1 illustrates a route recommendation system 1 according to an embodiment of the present disclosure.

Referring to FIG. 1, the route recommendation system 1 according to an embodiment may include a mobile device 10 and a vehicle 20. According to an embodiment, the mobile device 10 may be a mobile device of a user of the vehicle 20. Hereinafter, the mobile device 10 in the present disclosure may be referred to as a route recommendation apparatus.

According to an embodiment, the mobile device 10 and the vehicle 20 may communicate with each other. According to an embodiment, the mobile device 10 and the vehicle 20 may transmit and receive data using wireless communication or wired communication.

The wireless communication may include cellular communication using 5th generation (5G), long-term evolution (LTE), LTE-Advance (LTE-A), code division multiple access (CDMA), wideband CDMA (WCDMA), a universal mobile telecommunications system (UMTS), wireless broadband (WiBro), or global system for mobile communications (GSM).

Furthermore, the wireless communication may include wireless fidelity (Wi-Fi), Bluetooth, Bluetooth low energy (BLE), ZigBee, near field communication (NFC), magnetic secure transmission, a radio frequency (RF), or a body area network (BAN).

Furthermore, the wireless communication may include global navigation satellite system (GNSS). The GNSS may be a global positioning system (GPS), a global navigation satellite system (Glonass), Beidou Navigation Satellite System (hereinafter referred to as “Beidou”), or Galileo, the European global satellite-based navigation system.

The wired communications may include a universal serial bus (USB), a high definition multimedia interface (HDMI), recommended standard 232 (RS-232), power line communication, or a plain old telephone service (POTS).

According to an embodiment, the mobile device 10 may refer to a mobile device of the user. The mobile device 10 may be an electronic device capable of being easily carried and moved, which may include a video phone, a mobile phone, a smartphone, a wideband code division multiple access (WCDMA) device, a universal mobile telecommunication service (UMTS) device, a personal digital assistant (PDA) device, a portable multimedia player (PMP), a digital multimedia broadcasting (DMB) device, an E-book device, a portable computing device, or a digital camera.

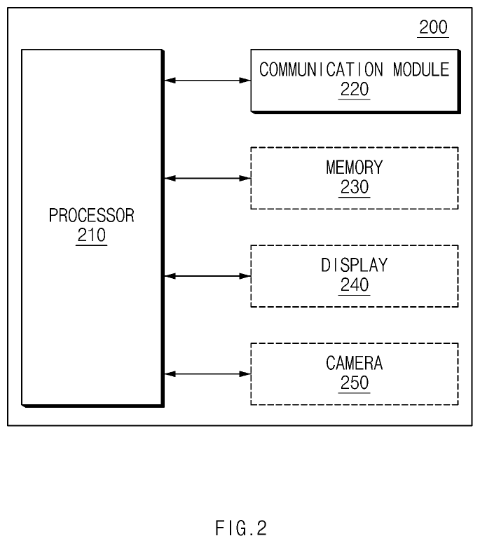

FIG. 2 is a block diagram of a route recommendation apparatus according to an embodiment of the present disclosure.

Referring to FIG. 2, a route recommendation apparatus 200 according to an embodiment may include a processor 210, a communication module 220, a memory 230, a display 240, and a camera 250. In various embodiments, the route recommendation apparatus 200 may include an additional component other than the components shown in FIG. 2, or may omit at least one of the components shown in FIG. 2.

According to an embodiment, the processor 210 may be electrically connected with the communication module 220, the memory 230, the display 240, and the camera 250 and may electrically control the respective components. The processor 210 may be an electrical circuit which executes instructions of software and may perform a variety of data processing and calculation described below.

According to an embodiment, the processor 210 may include, for example, an electronic control unit (ECU), a micro controller unit (MCU), or another sub-controller, which is loaded into the vehicle.

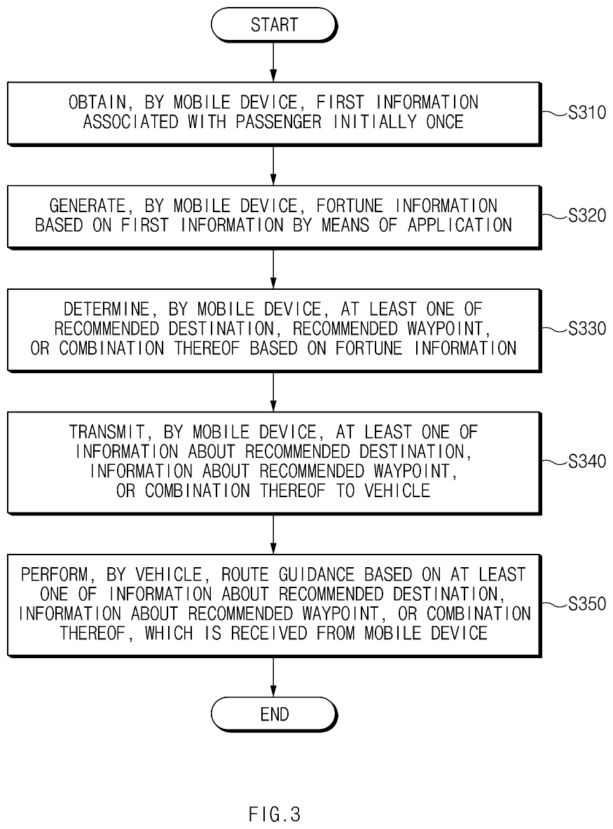

According to an embodiment, the processor 210 may execute calculation and data processing about control and/or communication of at least one other component of the route recommendation apparatus 200 using instructions stored in the memory 230. Detailed contents associated with an operation of the processor 210 will be described below with reference to FIG. 3.

According to an embodiment, the communication module 220 may include at least one of a mobile communication module, a wireless Internet module, a short-range communication module, or a combination thereof to communicate with the vehicle.

According to an embodiment, the mobile communication module may communicate with the vehicle over a mobile communication network established according to technical standards for mobile communication or a communication scheme (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like), 4th generation (4G) mobile telecommunication, or 5th generation (5G) mobile telecommunication.

According to an embodiment, the wireless Internet module may be a module for wireless Internet access, which may communicate with the vehicle through wireless LAN (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), or the like.

According to an embodiment, the short-range communication module may support short-range communication using at least one of Bluetooth™, radio frequency identification (RFID), infrared data association (IrDA), ultra wideband (UWB), ZigBee, near field communication (NFC), and wireless universal serial bus (USB) technologies or a combination thereof.

According to an embodiment, the memory 230 may store an image captured by the camera 250 under control of the processor 210.

According to an embodiment, the memory 230 may store at least one of a face of a user (e.g., a driver or a passenger) captured by the camera 250, user's palm lines, or a combination thereof.

For example, the memory 230 may include at least one type of storage medium such as a flash memory type memory, a hard disk type memory, a micro type memory, a card type memory (e.g., a secure digital (SD) card or an extreme digital (XI)) card), a random access memory (RAM), a static RAM (SRAM), a read-only memory (ROM), a programmable ROM (PROM), an electrically erasable PROM (EEPROM), a magnetic RAM (MRAM), a magnetic disk, an optical disk, or a combination thereof.

According to an embodiment, the display 240 may include at least one of a liquid crystal display (LCD), a thin film transistor-liquid crystal display (TFT-LCD), an organic light-emitting diode (OLED) display, a flexible display, a three-dimensional (3D) display, a transparent display, a head-up display (HUD), a touch screen, a cluster, or a combination thereof.

According to an embodiment, the display 240 may be implemented as a touch screen combined with a touch sensor to be used as an input device. For example, a touch film, a touch pad, or the like may be used as the touch sensor.

According to an embodiment, the display 240 may be implemented as a touch screen to receive user information from the user. For example, the user information may include at least one of a gender of the user, a user's year of birth, a user's month of birth, a user's date of birth, a user's time of birth, a blood type of the user, or a combination thereof.

According to an embodiment, the camera 250 may be a module which is provided in the route recommendation apparatus 200 to obtain an image associated with the user, which may capture at least one of a face of the user, user's palm lines, or a combination thereof.

FIG. 3 is a flowchart illustrating a route recommendation method according to an embodiment of the present disclosure.

Operations in S310 to S350 in an embodiment below may be sequentially performed, but are not necessarily sequentially performed. For example, an order of the respective operations may be changed, and at least two operations may be performed in parallel.

Referring to FIG. 3, in S310, a mobile device in a route recommendation system according to an embodiment may obtain first information associated with a passenger initially once.

According to an embodiment, a vehicle in the route recommendation system may include a navigation device, and the navigation device may display a first user interface (UI) corresponding to a first route option on a display provided in the navigation device.

According to an embodiment, in response to a user input for selecting the first UI, a processor in a route recommendation apparatus may automatically run its application.

According to an embodiment, the mobile device may obtain the first information associated with the passenger initially once by means of its camera. For example, the mobile device may capture at least one of a face of the passenger, passenger's palm lines, or a combination thereof by means of the camera.

According to an embodiment, the mobile device may obtain the first information associated with the passenger initially once by means of a user input.

According to an embodiment, the mobile device may obtain the first information associated with the passenger initially once by means of the application, in a state where the application is run.

For example, the mobile device may obtain at least one of a gender of the passenger, a passenger's year of birth, a passenger's month of birth, a passenger's date of birth, a passenger's time of birth, information about a blood type of the passenger, or a combination thereof, by means of a user input through the display.

According to an embodiment, in S320, the mobile device may generate fortune information based on the first information by means of the application.

According to an embodiment, the mobile device may analyze the first information of the passenger by means of the application. According to an embodiment, the processor may analyze physiognomy, palm lines, a zodiac sign, constellation, fortune-telling, or the like of the passenger based on the first information by means of the application.

According to an embodiment, the mobile device may analyze the first information of the passenger by means of the application to generate fortune information (e.g., today's fortune).

According to an embodiment, the fortune information may include information about at least one of a lucky direction, lucky food, a lucky shopping item, a lucky color, a lucky number, or a combination thereof.

According to an embodiment, in S330, the mobile device may determine at least one of a recommended destination, a recommended waypoint, or a combination thereof based on the fortune information.

According to an embodiment, the mobile device may determine at least one of a recommended destination, a recommended waypoint, or a combination thereof based on the fortune information generated by means of the application.

According to an embodiment, the mobile device determine the recommended waypoint based on an attention state of the passenger, fortune information of the passenger, a current time, a current position of the vehicle, and a set destination.

According to an embodiment, when the destination is not set, the mobile device may determine the recommended destination based on an attention state of the passenger, the fortune information of the passenger, a current time, and a current position of the vehicle.

According to an embodiment, in S340, the mobile device may transmit at least one of information about the recommended destination, information about the recommended waypoint, or a combination thereof to the vehicle through the communication module.

According to an embodiment, the mobile device may wiredly or wirelessly communicate with the vehicle to transmit at least one of information about the recommended destination, information about the recommended waypoint, or a combination thereof to the vehicle.

According to an embodiment, in S350, the vehicle may perform route guidance based on the at least one of the information about the recommended destination, the information about the recommended waypoint, or the combination thereof, which is received from the mobile device.

According to an embodiment, the vehicle may generate a route to at least one of the recommended destination, the recommended waypoint, or the combination thereof by means of the navigation device.

According to an embodiment, the vehicle may guide the driver along the route to the at least one of the recommended destination, the recommended waypoint, or the combination thereof by means of the navigation device.

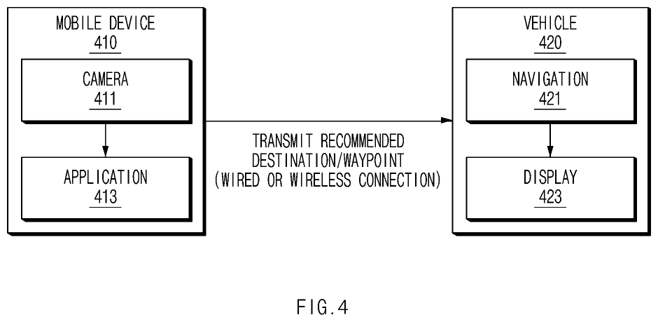

FIG. 4 illustrates route recommendation in a route recommendation system, an apparatus thereof, and a method thereof according to an embodiment of the present disclosure. Contents, which are duplicated with or correspond to the contents described above in conjunction with contents of FIG. 4, may be briefly described or omitted.

According to an embodiment, route recommendation in the route recommendation system, the apparatus thereof, and the method thereof may be performed using a mobile device 410 and a vehicle 420. In various embodiments, the route recommendation in the route recommendation system, the apparatus thereof, and the method thereof may be performed by using an additional component other than the components shown in FIG. 4 or omitting at least one of the components shown in FIG. 4. In the present disclosure, the mobile device 410 may be referred to as a route recommendation apparatus or the like.

Referring to 4, according to an embodiment, the mobile device 410 may obtain first information associated with a passenger.

According to an embodiment, the mobile device 410 may obtain the first information associated with the passenger initially once by means of a camera 411. For example, the first information obtained by means of the camera 411 by the mobile device 410 may include at least one of a face of the passenger, passenger's palm lines, or a combination thereof.

According to an embodiment, the mobile device 410 may obtain the first information associated with the passenger by means of a user input. For example, the first information obtained by means of the user input by the mobile device 410 may include at least one of a gender of the passenger, a passenger's year of birth, a passenger's month of birth, a passenger's date of birth, a passenger's time of birth, information about a blood type of the passenger, or a combination thereof.

According to an embodiment, the mobile device 410 may analyze the first information associated with the passenger by means of an application 413. For example, a software application containing computer executable code that when executed is configured to perform a function and/or series of functions.

According to an embodiment, the mobile device 410 may generate fortune information based on the first information associated with the passenger by means of the application 413.

According to an embodiment, the mobile device 410 may derive (or determine) at least one of a recommended destination, a recommended waypoint, or a combination thereof, based on the generated fortune information.

According to an embodiment, the mobile device 410 may transmit the at least derived one of the information about the recommended destination, the information about the recommended waypoint, or the combination thereof to the vehicle 420.

According to an embodiment, navigation (or a navigation device) 421 may display navigation information on a display 423 provided in the navigation 421.

According to an embodiment, the display 423 may display at least one route option. For example, the at least one route option may include a minimum time route option, a highway priority route option, a free road route option, a lucky route option, and the like.

According to an embodiment, the vehicle 420 may perform route guidance by means of the navigation 421, based on at least one of the information about the recommended destination, the information about the recommended waypoint, or the combination thereof.

According to an embodiment, the vehicle 420 may guide the driver along a route to the recommended destination or the recommended waypoint, which is received from the mobile device 410, in response to a user input for selecting the lucky route option by means of the display 423.

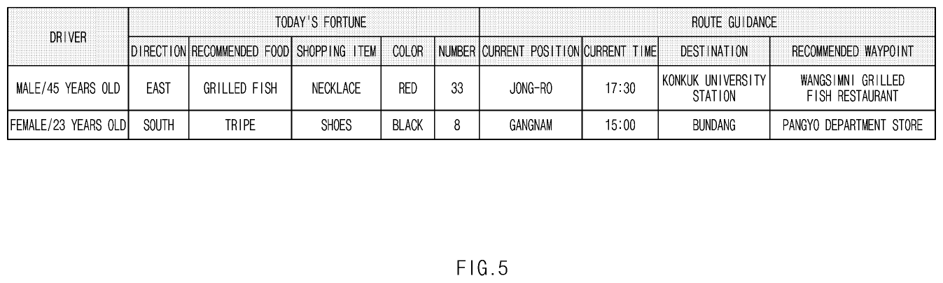

FIG. 5 illustrating an example of determining recommended waypoints based on fortune information in a route recommendation apparatus and a method thereof according to an embodiment of the present disclosure.

Referring to FIG. 5, according to an embodiment, the route recommendation apparatus may determine a recommended waypoint based on an attention state of a passenger, fortune information of the passenger, a current time, a current position of a vehicle, and a set destination. According to an embodiment, the attention state of the passenger may be determined based on an on or off state of a driver attention wanting (DAW).

According to an embodiment, the route recommendation apparatus may determine a place located on a route to a destination as the recommended waypoint, based on the set destination.

In an embodiment, the route recommendation apparatus may derive today's fortune based on a gender (e.g., male) and an age (e.g., 45 years old) of a driver.

In an embodiment, today's fortune may include a lucky direction (e.g., east), lucky food (e.g., grilled fish), a lucky shopping item (e.g., a necklace), a lucky color (e.g., red), and/or a lucky number (e.g., 33).

In an embodiment, the route recommendation apparatus may determine a recommended waypoint (e.g., a Wangsimni grilled fish restaurant) based on today's fortune, a current time (e.g., 17:30), a current position (e.g., Jong-ro) of the vehicle, and a set destination (e.g., Konkuk University Station).

In another embodiment, the route recommendation apparatus may derive today's fortune based on a gender (e.g., female) and an age (e.g., 23 years old) of a driver.

In the other embodiment, today's fortune may include a lucky direction (e.g., south), lucky food (e.g., tripe), a lucky shopping item (e.g., shoes), a lucky color (e.g., black), and/or a lucky number (e.g., 8).

In the other embodiment, the route recommendation apparatus may determine a recommended waypoint (e.g., Pangyo Department Store) based on today's fortune, a current time (e.g., a current position (e.g., Gangnam) of the vehicle, and a set destination (e.g., Bundang).

According to an embodiment, the route recommendation apparatus may transmit information about the derived recommended waypoint to the vehicle.

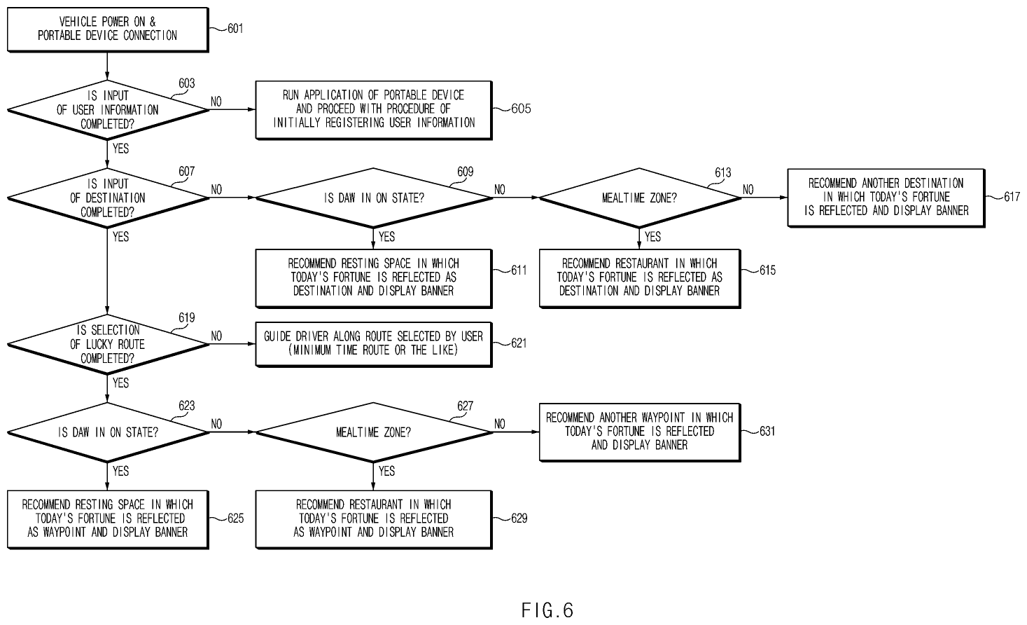

FIG. 6 illustrates a flowchart of determining at least one of a recommended destination, a recommended waypoint, or a combination thereof in a route recommendation system and a method thereof according to an embodiment of the present disclosure.

Operations in S601 to S631 in an embodiment below may be sequentially performed, but are not necessarily sequentially performed. For example, an order of the respective operations may be changed, and at least two operations may be performed in parallel.

Referring to FIG. 6, when a vehicle is powered on, in S601, a route recommendation apparatus in the route recommendation system according to an embodiment may be connected with the vehicle.

According to an embodiment, the route recommendation apparatus in the route recommendation system may be connected with the vehicle using wireless communication or wired communication.

According to an embodiment, in S603, the route recommendation apparatus in the route recommendation system may determine whether the input of user information is completed.

According to an embodiment, the user information may include at least one of a user's gender input from the user, a user's year of birth, a user's month of birth, a user's date of birth, and a user's time of birth input from the user, information about a user's blood type input from the user, a user's face captured by means of a camera of the route recommendation apparatus, user's palm lines captured by means of the camera, or a combination thereof.

When it is determined that the input of the user information is not completed (No in S603), in S605, the route recommendation apparatus may run an application to proceed with a procedure of initially registering user information.

According to an embodiment, the route recommendation apparatus may receive a user input through the application to register the user information initially once or may obtain the user information initially once by means of the camera.

According to an embodiment, when it is determined that the input of the user information is not completed (Yes in S603), in S607, the route recommendation apparatus may determine whether the input of a destination is completed.

According to an embodiment, when it is determined that the input of the user information is completed, the route recommendation apparatus may determine whether the destination is set by means of at least one of a navigation device provided in the vehicle, the route recommendation apparatus, or a combination thereof.

According to an embodiment, when the destination is not set, the route recommendation apparatus may determine a recommended destination based on an attention state of the user, fortune information of the user, a current time, and a current position of the vehicle.

According to an embodiment, when it is determined that the input of the destination is not completed (No in S607), in S609, the route recommendation apparatus may identify whether a driver attention warning (DAW) is in an on state.

According to an embodiment, the attention state of the user may be determined based on an on or off state of the DAW. For example, when the DAW is in the on-state, it may be determined that the attention state of the user is low. For another example, when the DAW is in the off-state, it may be determined that the attention state of the user is not low.

According to an embodiment, when it is determined that the DAW is in the on-state (Yes in S609), in S611, the route recommendation apparatus may recommend a resting space in which today's fortune is reflected as a destination and the vehicle may display a banner recommending the resting space on a display of the navigation.

According to an embodiment, when it is determined that the DAW is in the on-state, the route recommendation apparatus may determine that the attention state of the user is low to determine the resting space in which today's fortune is reflected as a recommended destination and may transmit information about the resting space to the vehicle.

According to an embodiment, the vehicle may generate a route to the resting space based on the information about the resting space, which is received from the route recommendation apparatus, and may guide the driver along the route to the resting space by means of the navigation device.

According to an embodiment, when it is determined that the DAW is not in the on state (No in S609), in S613, the route recommendation apparatus may determine whether the current time is a mealtime zone. For example, a mealtime zone time period may include a time period before and after time periods in which individuals may have breakfast, lunch, and/or dinner. In at least one implementation, a lunch time mealtime zone time period is about an hour before and an hour after noon. In another implementation, a breakfast time mealtime zone time period is about an hour before and an hour after 8:00 AM. In another implementation, a dinner time mealtime zone time period is about an hour before and an hour after 7:00 PM. Of course, it shall be understand that these specific time period may be different in different countries and as such in some implementations they are user configurable.

According to an embodiment, when it is determined that the DAW is not in the on state, the route recommendation apparatus may determine that the attention state of the user is not low and may determine whether the current time is the mealtime zone.

According to an embodiment, when it is determined that the current time is the mealtime zone (Yes in S613), in S615, the route recommendation apparatus may recommend a restaurant in which today's fortune is reflected as a destination and the vehicle may display a banner recommending the restaurant on the display of the navigation.

According to an embodiment, when it is determined that the current time is the mealtime zone, the route recommendation apparatus may determine the restaurant in which today's fortune is reflected as a recommended destination and may transmit information about the restaurant to the vehicle.

According to an embodiment, the vehicle may generate a route to the restaurant based on the information about the restaurant, which is received from the route recommendation apparatus, and may guide the driver along a route to the restaurant by means of the navigation device.

According to an embodiment, when it is determined that the current time is not the mealtime zone (No in S613), in S617, the route recommendation apparatus may recommend a space (e.g., a space rather than a resting space or a restaurant) in which today's fortune is reflected as a destination and the vehicle may display a banner recommending the space in which today's fortune is reflected on the display of the navigation.

According to an embodiment, when it is determined that the current time is not the mealtime zone, the route recommendation apparatus may determine another place in which today's fortune is reflected as a recommended destination and may transmit information about the other place to the vehicle.

According to an embodiment, the vehicle may generate a route to the other place based on the information about the other place, which is received from the route recommendation apparatus, and may guide the driver along a route to the other place by means of the navigation device.

According to an embodiment, when it is determined that the input of the destination is completed (Yes in S607), in S619, the route recommendation apparatus may determine whether the selection of the lucky route is completed.

According to an embodiment, the route recommendation apparatus may automatically run an application in response to a user input for selecting a UI corresponding to a lucky route option by means of one of the display provided in the navigation of the vehicle or the route recommendation apparatus.

According to an embodiment, the application may refer to an application for generating fortune information based on user information and determining at least one of a recommended destination, a recommended waypoint, or a combination thereof based on the fortune information.

According to an embodiment, when it is determined that the input of the destination is completed and the selection of the lucky route is completed, the route recommendation apparatus may determine a recommended waypoint based on an attention state of the user, the fortune information of the user, a current time, a current position of the vehicle, and the set destination.

According to an embodiment, when it is determined that the selection of the lucky route is not complicated (No in S619), in S621, the route recommendation apparatus may guide the driver along a route selected by the user.

For example, when it is determined that the selection of the lucky route is not completed, the route recommendation apparatus may guide the driver along one of a minimum time route, a highway priority route, or a free road route.

According to an embodiment, when it is determined that the selection of the lucky route is completed (Yes in S619), in S623, the route recommendation apparatus may identify whether the DAW is in an on state.

According to an embodiment, when it is determined that the DAW is in the on-state (Yes in S623), in S625, the route recommendation apparatus may recommend a resting space in which today's fortune is reflected as a waypoint and the vehicle may display a banner recommending the resting space on a display of the navigation.

According to an embodiment, when it is determined that the DAW is not in the on state (No in S623), in S627, the route recommendation apparatus may determine whether the current time is a mealtime zone.

According to an embodiment, when it is determined that the current time is the mealtime zone (Yes in S627), in S629, the route recommendation apparatus may recommend a restaurant in which today's fortune is reflected as a waypoint and the vehicle may display a banner recommending the restaurant on the display of the navigation.

According to an embodiment, when it is determined that the current time is not the mealtime zone (No in S627), in S631, the route recommendation apparatus may recommend a space (e.g., a space rather than a resting space or a restaurant) in which today's fortune is reflected as a waypoint and the vehicle may display a banner recommending the space in which today's fortune is reflected on the display of the navigation.

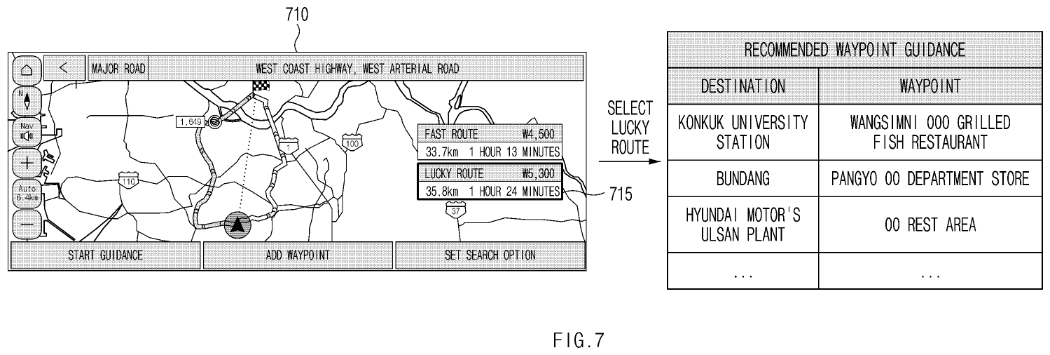

FIG. 7 illustrates recommending a waypoint in a route recommendation system and a method thereof according to an embodiment of the present disclosure. Contents, which are duplicated with or correspond to the contents described above in conjunction with contents of FIG. 7, may be briefly described or omitted.

Referring to FIG. 7, a vehicle in the route recommendation system according to an embodiment may include a navigation device.

According to an embodiment, the vehicle may generate a lucky route based on information about a recommended waypoint, which is received from a mobile device, and a set destination. For example, the recommended waypoint may be a place located on a route to the set destination.

According to an embodiment, the navigation device may display a first user interface (UI) 715 corresponding to a first route option (e.g., a lucky route) on a display 710 provided in the navigation device.

According to an embodiment, the vehicle in the route recommendation system according to an embodiment may guide the driver along the generated lucky route in response to a user input for selecting the first UI 715.

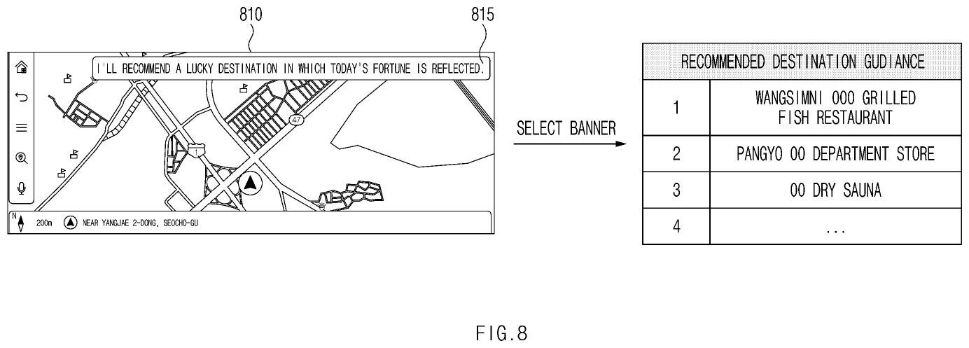

FIG. 8 illustrates recommending a destination in a route recommendation system and a method thereof according to an embodiment of the present disclosure.

Referring to FIG. 8, a vehicle in the route recommendation system according to an embodiment may include a navigation device.

According to an embodiment, the vehicle may generate a lucky route based on information about a recommended destination, which is received from a mobile device.

According to an embodiment, the navigation device may display a second UI 815 corresponding to a lucky route on a display 810 provided in the navigation device.

For example, the second UI 815 may include a banner form where a message (e.g., “I'll recommend a lucky destination in which today's fortune is reflected.”) is displayed.

According to an embodiment, in response to a user input for selecting the second UI 815, the vehicle may perform route guidance based on the lucky route.

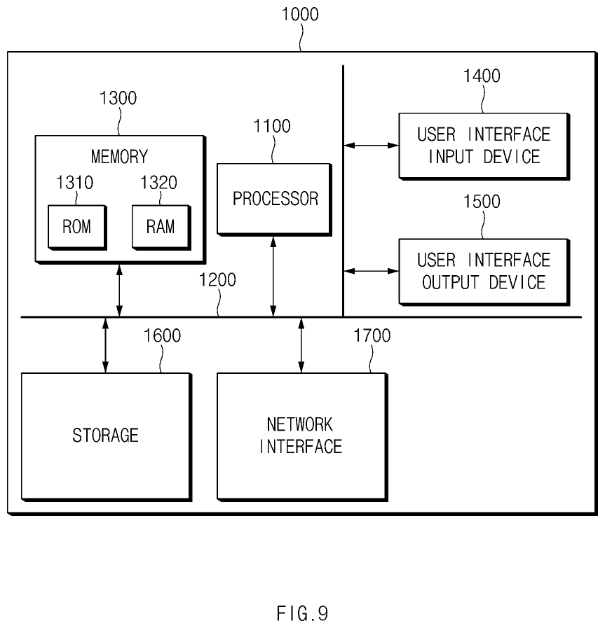

FIG. 9 illustrates a computing system about a route recommendation system of a vehicle, an apparatus thereof, and a method thereof according to an embodiment of the present disclosure.

Referring to FIG. 9, a computing system 1000 about the route recommendation system of the vehicle, the apparatus thereof, and the method thereof may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the route recommendation system, the apparatus thereof, and the method thereof according to an embodiment of the present disclosure.

According to at least one of embodiments of the present disclosure, the route recommendation system, the apparatus thereof, and the method thereof according to an embodiment of the present disclosure may be provided to guide a driver along a recommend route to be lucky, in which today's fortune is reflected, by means of navigation to provide the driver and a passenger with pleasure.

Furthermore, according to at least one of embodiments of the present disclosure, the route recommendation system, the apparatus thereof, and the method thereof according to an embodiment of the present disclosure may be provided to provide various route guidance options including a lucky route option, thus improving user experiences of the driver and the passenger.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A route recommendation system, comprising:
a mobile device configured to:
obtain first information associated with a passenger and generate fortune information based on the first information by utilizing an application of the mobile device;
determine at least one of: a recommended destination, a recommended waypoint, and/or a combination thereof based on the fortune information; and
transmit at least one of: information about the recommended destination, information about the recommended waypoint, and/or a combination thereof, and
a vehicle configured to:
receive the transmit information about the recommended destination, the information about the recommended waypoint, and/or the combination thereof from the mobile device; and
perform route guidance based on the information received from the mobile device.

2. The route recommendation system of claim 1, wherein the mobile device includes a camera, and
wherein the first information includes at least one type of information input by the passenger and/or acquired by the camera,
wherein the information input by the passenger includes at least one of: the passenger's gender, the passenger's year of birth, the passenger's month of birth, the passenger's day of birth, the passenger's time of birth, and/or information about the passenger's blood type, and
wherein the information acquired by the camera includes at least one of: information pertaining to the passenger's face, information pertaining to the passenger's palm lines, and/or a combination thereof.

3. The route recommendation system of claim 1, wherein the vehicle includes a navigation device,
wherein the navigation device is configured to display a first user interface (UI) corresponding to a first route option on a display, and
wherein, in response to a user input for selecting the first UI, the application of the mobile device is automatically run.

4. The route recommendation system of claim 1, wherein the vehicle includes a navigation device, the navigation device being configured to:
generate a lucky route based on information received from the mobile device, the information received from the mobile device including at least one of: the information about the recommended destination, the information about the recommended waypoint, and/or the combination thereof; and
display a second UI corresponding to the lucky route on a display, and perform the route guidance based on the lucky route in response to a user input for selecting the second UI.

5. The route recommendation system of claim 1, wherein the mobile device is further configured to:
determine the recommended waypoint based on an attention state of the passenger, the fortune information, a current time, a current position of the vehicle, and a set destination, and
wherein the attention state of the passenger is determined based on: an on state or an off state of a driver attention warning (DAW).

6. The route recommendation system of claim 5, wherein the mobile device is further configured to:
determine a resting space as the recommended waypoint if the DAW is in the on state, and
determine a restaurant as the recommended waypoint if the DAW is in the off state and if the current time is within a mealtime zone time period.

7. The route recommendation system of claim 1, wherein the mobile device is further configured to:
determine the recommended destination based on an attention state of the passenger, the fortune information, a current time, and a current position of the vehicle, and
wherein the attention state of the passenger is determined based on: an on state or an off state of a DAW.

8. The route recommendation system of claim 7, wherein the mobile device is further configured to:
determine a resting space as the recommended destination if the DAW is in the on state, and
determine a restaurant as the recommended destination if the DAW is in the off state.

9. The route recommendation system of claim 1, wherein the fortune information includes information about at least one of: a lucky direction, lucky food, a lucky shopping item, a lucky color, a lucky number, and/or a combination thereof.

10. A route recommendation apparatus, comprising:
a communication module configured to communicate with a vehicle; and
at least one processor configured to control the communication module,
wherein the at least one processor is configured to:
obtain first information associated with a passenger;
generate fortune information based on the first information by utilizing an application;
determine at least one of a recommended destination, a recommended waypoint, and/or a combination thereof based on the fortune information; and
transmit at least one of: information about the recommended destination, information about the recommended waypoint, and/or a combination thereof to the communication module.

11. The route recommendation apparatus of claim 10, further comprising:
a camera,
wherein the first information includes at least one type of information input by the passenger and/or acquired by the camera,
wherein the information input by the passenger includes at least one of: the passenger's gender, the passenger's year of birth, the passenger's month of birth, the passenger's day of birth, the passenger's time of birth, and/or information about the passenger's blood type,
wherein the information acquired by the camera includes at least one of: information pertaining to the passenger's face, information pertaining to the passenger's palm lines, and/or a combination thereof.

12. The route recommendation apparatus of claim 10, wherein the at least one processor is further configured to determine the recommended waypoint based on an attention state of the passenger, the fortune information, a current time, a current position of the vehicle, and a set destination, and
wherein the attention state of the passenger is determined based on an on state or an off state of a driver attention warning (DAW).

13. The route recommendation apparatus of claim 12, wherein the at least one processor is further configured to:
determine a resting space as the recommended waypoint if the DAW is in the on state, and
determine a restaurant as the recommended waypoint if the DAW is in the off state.

14. The route recommendation apparatus of claim 10, wherein the at least one processor is further configured to:
determine the recommended destination based on: an attention state of the passenger, the fortune information, a current time, and a current position of the vehicle, and
wherein the attention state of the passenger is determined based on: an on state or an off state of a DAW.

15. The route recommendation apparatus of claim 14, wherein the at least one processor is further configured to:
determine a resting space as the recommended destination if the DAW is in the on state, and
determine a restaurant as the recommended destination if the DAW is in the off state and when the current time is a mealtime zone time period.

16. The route recommendation apparatus of claim 10, wherein the fortune information includes information about at least one of: a lucky direction, lucky food, a lucky shopping item, a lucky color, a lucky number, and/or a combination thereof.

17. A route recommendation method, comprising:
obtaining, by a mobile device, first information associated with a passenger;
generating, by an application of the mobile device, fortune information based on the first information;
determining, by the mobile device, at least one of: a recommended destination, a recommended waypoint, and/or a combination thereof based on the fortune information;
transmitting, by the mobile device, at least one of: information about the recommended destination, information about the recommended waypoint, and/or a combination thereof;
receiving the information about the recommended destination, the information about the recommended waypoint, and/or the information about the recommended waypoint, and
performing route guidance based on the information received from the mobile device.

18. The route recommendation method of claim 17, wherein the first information includes at least one type of information input by the passenger and/or acquired by a camera of the mobile device,
wherein the information input by the passenger includes at least one of the passenger's gender, the passenger's year of birth, the passenger's month of birth, the passenger's day of birth, the passenger's time of birth, and/or information about the passenger's blood type, and
wherein the information acquired by the camera includes at least one of: information pertaining to the passenger's face, information pertaining to the passenger's palm lines, and/or a combination thereof.

19. The route recommendation method of claim 17, wherein the determining of the at least one of the recommended destination, the recommended waypoint, and/or the combination thereof step further includes:
determining, by the mobile device, the recommended waypoint based on: an attention state of the passenger, the fortune information, a current time, a current position of the vehicle, and a set destination, and
wherein the attention state of the passenger is determined based on an on state or on an off state of a driver attention warning (DAW).

20. The route recommendation method of claim 17, wherein the determining of the at least one of the recommended destination, the recommended waypoint, and/or the combination thereof step further includes:
determining the recommended destination based on: an attention state of the passenger, the fortune information, a current time, and a current position of the vehicle, and
wherein the attention state of the passenger is determined based on an on state or on an off state of a DAW.
